(19) United States
(12) Patent Application Publication
(10) Pub. No.: US 2007/0096543 A1
(43) Pub. Date: May 3, 2007

(54) Wheel cover structure of an aluminum alloy wheel

(76) Inventor: Yung-Ting Hsieh, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/262,713

(22) Filed: Nov. 1, 2005

(51) Int. Cl. B60B 7/04

(52) U.S. Cl. 301/37.28; 301/37.33

(57) ABSTRACT

A wheel cover has several through holes thereon, and several wall portions encompassing respective ones of the through holes; the encompassing wall portions project from an inner side of the wheel cover and abut respective ones of the edges of the through holes; the encompassing wall portions each have several detained protrusions on an outward side of a tail end thereof; the wheel cover is joined to an aluminum alloy wheel, which has several hollow portions, with the encompassing wall portions thereof being passed through respective ones of the hollow portions, and with the detained protrusions being tightly pressed against inner ends of the hollow portions and detained in the aluminum alloy wheel; thus, the wheel cover is firmly held on the aluminum alloy wheel.

### BACKGROUND OF THE INVENTION

1. Field of the Invention

The present invention relates to a wheel cover of an aluminum alloy wheel, more particularly one, which is relatively easy, fast and cheap to manufacture, and can't form any scratch on an aluminum alloy wheel in assembly.

2. Brief Description of the Prior Art

Wheel covers are secured on wheels to make the wheels more attractive and pleasant-looking. A common wheel cover is provided to an aluminum alloy wheel, which has an edge protrusion, and several hollow portions. The wheel cover has several through holes thereon, equidistant first insertion trenches near to an edge thereof, metallic fastening plates secured on the first insertion trenches, several extension wall portions encompassing respective ones of the through holes, second insertion trenches on the extension wall portions, and metallic securing plates inserted in the second insertion trenches. The wheel cover is firmly held on the aluminum alloy wheel with the through holes facing respective ones of the hollow portions, the fastening plates being connected to the edge protrusion, and the securing plates being pressed against and stopped by inner ends of the hollow portions of the aluminum alloy wheel to prevent the wheel cover from falling off. Therefore, the wheel cover can be rapidly joined to and separated from the aluminum alloy wheel.

However, the wheel cover is relatively time-consuming and expensive to manufacture because it has the first insertion trenches near to the edge, the fastening plates secured on the first insertion trenches, the second insertion trenches, and the securing plates inserted in the second insertion trenches. Furthermore, when the wheel cover is being secured in position, the fastening plates and the securing plates, which are made of metal are prone to form scratches on the aluminum alloy wheel.

Another kind of wheel cover is provided to a recessed-surfaced aluminum alloy wheel, which has several holes. The wheel cover has several through holes thereon, extension wall portions extending from an inner side to encompass respective ones of the through holes, insertion trenches on intermediate portions of the extension wall portions, and elastic plates inserted in the insertion trenches. Furthermore, the extension wall portions have protruding plates on the insertion trenches, and the elastic plates each include an insertion portion, a pressing portion, and a sloping portion; the insertion portions of the elastic plates are inserted in the insertion trenches of the extension wall portions; the pressing portions of the elastic plates extend in a sloping manner; in assembly, the protruding plates will be pressed against hole-defining inward edges of one side of the aluminum alloy wheel, which define the holes while the elastic plates will be passed through the holes, and pressed against hole-defining inward edges of the other side of the aluminum alloy wheel.

From the above description, it can be easily seen that the wheel cover is time-consuming and expensive to manufacture, and prone to form scratches on the recessed-surfaced aluminum alloy wheel, like the first common one.

### SUMMARY OF THE INVENTION

It is a main object of the invention to provide an improvement on a wheel cover of an aluminum alloy wheel to overcome the above problem. The wheel cover of the present invention has several through holes thereon, and several wall portions encompassing respective ones of the through holes. The encompassing wall portions extend from an inner side of the wheel cover and abut respective ones of the edges of the through holes. And, the encompassing wall portions each have several detained protrusions on an outward side of a tail end thereof. The wheel cover is joined to an aluminum alloy wheel, which has several hollow portions, with the encompassing wall portions thereof being passed through respective ones of the hollow portions, and with the detained protrusions being tightly pressed against inner ends of the hollow portions and detained in the aluminum alloy wheel; thus, the wheel cover is firmly supported on the aluminum alloy wheel without risk of falling off.

### BRIEF DESCRIPTION OF THE DRAWINGS

The present invention will be better understood by referring to the accompanying drawings, wherein:

FIG. 1 is a perspective view of the wheel and the wheel cover in the present invention,

FIG. 2 is a side view of the wheel cover in the invention, and

FIG. 3 is a lateral sectional view of the present invention.

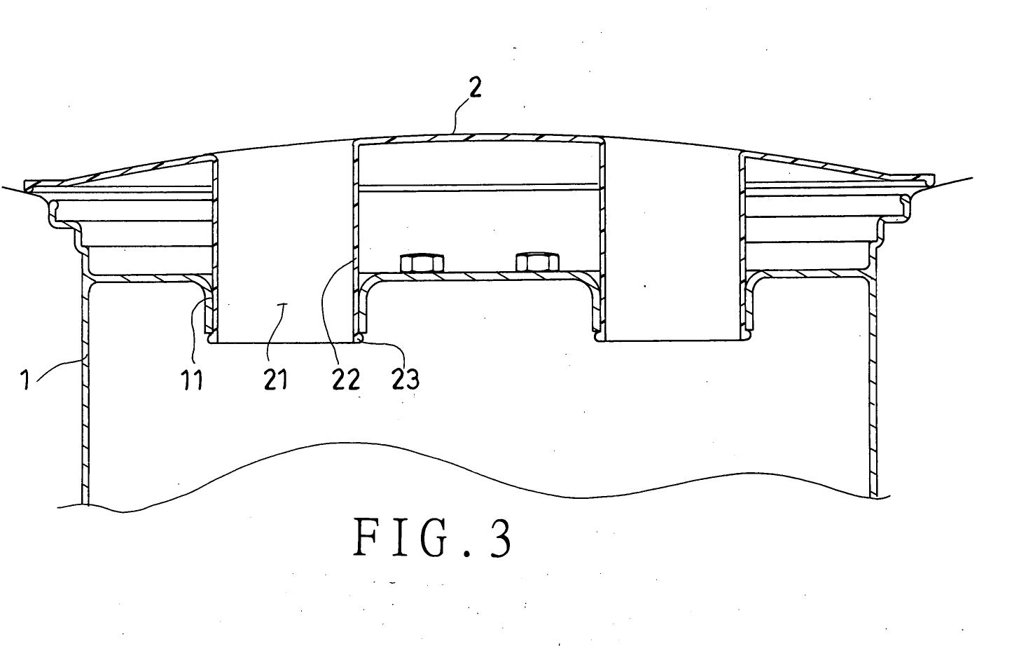

### DETAILED DESCRIPTION OF THE PREFERRED EMBODIMENTS

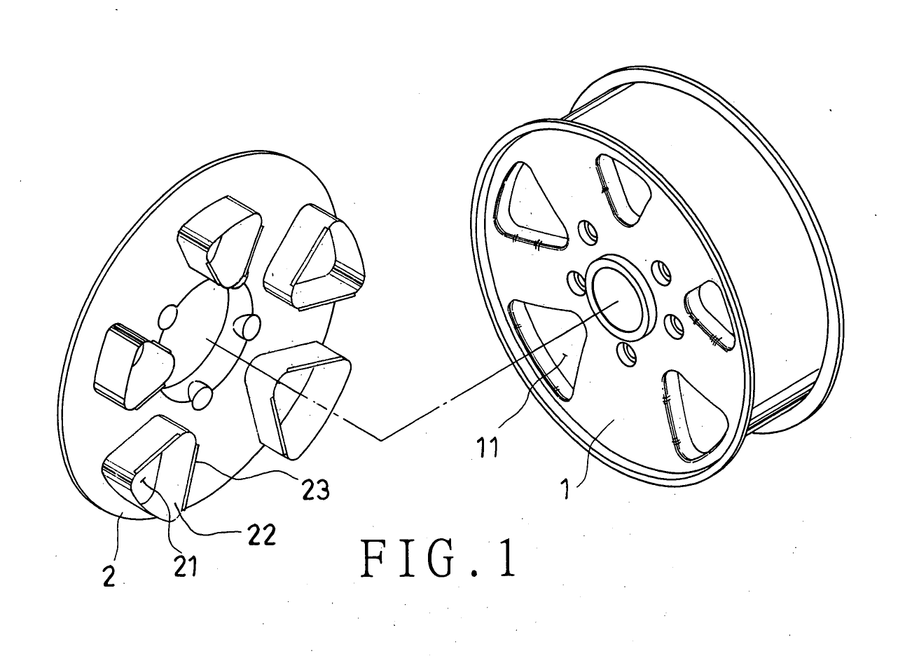

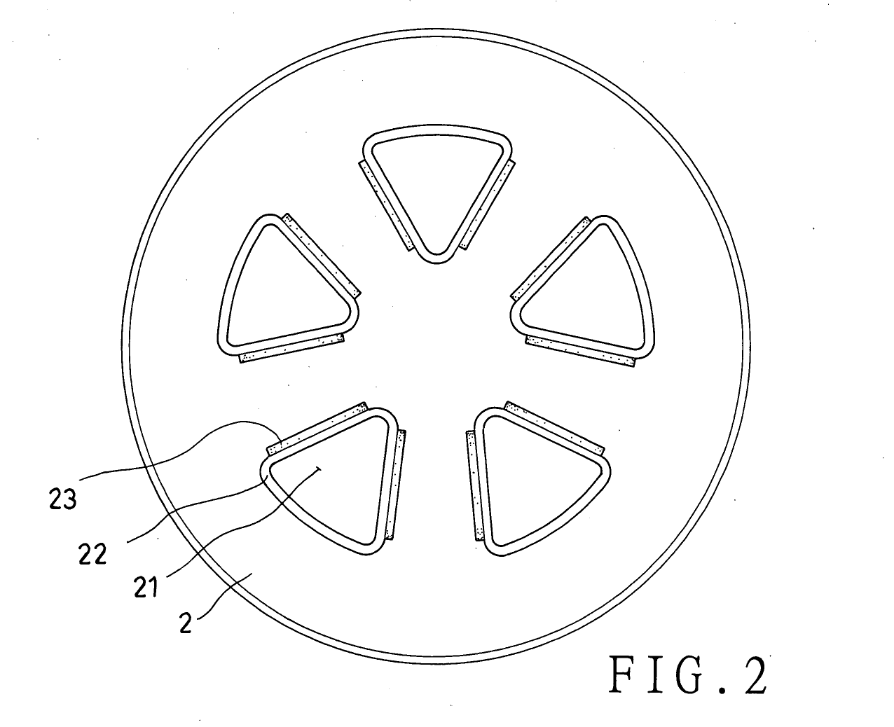

Referring to FIGS. 1 and 2, a preferred embodiment of a wheel cover 2 is provided to an aluminum alloy wheel 1, which has several hollow portions 11 with a certain shape.

The wheel cover 2 has several through holes 21 thereon, and several encompassing wall portions 22 encompassing respective ones of the through holes 21, which encompassing wall portions 22 extend from an inner side of the wheel cover 2, and abut respective ones of the edges of the through holes 21. Furthermore, the encompassing wall portions 22 each have several detained protrusions 23 on an outward side of a tail end thereof.

The wheel cover 2 is joined to the aluminum alloy wheel 1 with the encompassing wall portions 22 being passed through respective ones of the hollow portions 11, and with the detained protrusions 23 tightly touching inner ends of the hollow portions 11 of the aluminum alloy wheel 1. Therefore, the wheel cover 2 is firmly held on the aluminum alloy wheel 1 with the through holes 21 being right in front of respective ones of the hollow portions 11, and the detained protrusions 23 being tightly pressed against and detained in the wheel 1.

From the above description, it can be easily seen that the wheel cover of the present invention is easier, faster and cheaper to manufacture than the conventional wheel cover described in Background. And, the wheel cover of the invention can't form any scratch on the aluminum alloy wheel in assembly.

What is claimed is:

1. Wheel cover structure of an aluminum alloy wheel, comprising
a plurality of through holes on a wheel cover;
a plurality of encompassing wall portions encompassing respective ones of the through holes; the encompassing wall portions projecting from an inner side of the wheel cover and abutting respective ones of edges of the through holes; and
a plurality of detained protrusions on an outward side of a tail end of each of the encompassing wall portions;
the wheel cover being joined to an aluminum alloy wheel, which has a plurality of hollow portions, with the encompassing wall portions thereof being passed through respective ones of the hollow portions, and with the detained protrusions being tightly pressed against inner ends of the hollow portions and detained in the aluminum alloy wheel to prevent the wheel cover from falling off.
